(19) United States
(12) Patent Application Publication
(10) Pub. No.: US 2006/0116111 A1
(43) Pub. Date: Jun. 1, 2006

(54) Cell or mobile phone voice mail or message method of transfer

(76) Inventor: Michael Edward Klicpera, La Jolla, CA (US)

Correspondence Address: MICHAEL E. KLICPERA, PO BOX 573, LA JOLLA, CA, 92038-0573, US

(21) Appl. No.: 11/291,586

(22) Filed: Dec. 1, 2005

Related U.S. Application Data
(60) Provisional application No. 60/632,020, filed on Dec. 1, 2004.

(51) Int. Cl. H04M 11/10

(52) U.S. Cl. 455/413

(57) ABSTRACT

Disclosed herein is a method which allows the cell or mobile phone company or the cell phone user or owner to download voice mail, voice messages, or recorded calls or conversations to the user's or owner's personal e-mail or for delivery by a mail means on a hard disk or chip media in a format that can be used to store and play the voice mail or messages from the individual's computer. The option mode on the cell or mobile phone can be programmed to allow the cell or mobile phone user or owner to download one or more voicemail or message recordings to his or her personal e-mail account. Also, should the number of voice mail or message recordings exceed the number, time, and/or duration storage limit(s) for that particular individual's cell or mobile phone account, the cell or mobile phone company can initiate and complete the downloading of voice mail or messages. Since the cell or mobile phone voice mail or messages are already stored in a digital means using vocoder technology, the particular stored digital format can be efficiently converted to one of the typical sound generating formats found on PC or MAC computers. Such formats are known as WAV, Windows Media Audio Series, RealAudio, Quicktime6, Wave64, OGG Vorbis, MP3, MIDI, CD Audio, Perfect Clarity Audio, Dialogic VOX ADPCM or AIFF format IBM-PC compatible Personal Computer (PC) and Apple Macintosh computers.

### CROSS-REFERENCES TO RELATED APPLICATIONS

This patent application is based upon provisional application No. 60/632,020 filed on Dec. 1, 2004 and entitled “Cell or Mobile Phone Voice Mail or Message Method of Transfer” for which priority is claimed. All of this provisional application is incorporated herein by this reference.

### FIELD OF THE INVENTION

The field of art to which this invention relates is cell, mobile and portable phones, and computer and internet technology. More specifically, the present invention relates to a method for downloading or transferring recorded and stored voice mail or messages from a cell company storage facility to either 1) an individual's e-mail address or 2) copied on a hard media for mail delivery in an IBM-PC (Personal Computer) compatible computer or Apple Macintosh computer audio format.

### BACKGROUND OF THE INVENTION

Cell, mobile and portable phones must communicate with wireless transmitting and receiving towers that are installed, operated and maintained by various cell, mobile and portable phone service or provider companies. Some of the current and larger service or provider companies are Sprint Corporation, Verizon Communication Inc., AT&T Wireless, T-Mobile and Cingular and will be referred to as cell or mobile phone companies in this application. It also should be noted that the Applicant asserts that the terms ‘cell phone’, ‘mobile phone’ and ‘portable phone’ are interchangeable through this application. Some of the current and larger cell or mobile phone manufacturers or distributors are Qualcomm, LG Industries, Nokia, Sony, Samsung, Ericsson, Kyocera, and Motorola. The cell or mobile phone has voice service software technology which stores unanswered or auto answering machine phone recordings in a voice memo or message storage box, folder or computer database. This technology will be referred to herein as voice mail or message. Furthermore, the some cell or mobile phones allow recorded conversations which are saved into the voice mail or message storage medium.

The cell or mobile phone technology generally allows an individual to subsequently playback or listen to new and stored voice mail messages or voice recordings in the voice mail or message storage medium. The recorded voice mail or message is stored in a password protected mailbox for the cell or mobile phone owner (user, operator) to subsequently access. The owner can listen to the voice mail or message using a land home phone, office phone, cell or mobile phone. The accompanying cell phone audible information generally provides the cell or mobile phone owner with certain information such as the date and time each voice mail or recorded conversation was stored. This generally occurs just prior to playback of each voice mail over the cell or mobile phone's speaker. Generally after a voice mail or message has completed playback, the operator has several options, i.e. option mode. Cell or mobile phone technology also commonly allows the operator to interrupt the playback mode by pressing one or more designated keys on the cell or mobile phone's keyboard in order to immediately enter the option mode. Commonly, the option mode provides the operator the following choices; 1) to delete the voice mail or message, 2) to save the voice mail or message, or 3) to forward the voice mail or message to another cell or mobile phone, by pressing one or more designated keys on the cell or mobile phone's keyboard. Selecting the second option generally saves the voice mail or message on the cell or mobile company's computer database. The cell or mobile phone technology typically allows the operator to play the voice mail or message at a subsequent time or day and select one of the options described in the option mode. After a certain number of voice mail or messages have been saved to the cell or mobile phone's storage box or folder, exceed the number of voice mails or messages stored or after a certain accumulated total recorded time is reached or exceeded, the cell or mobile phone company may have the option to delete the oldest voice mail or message, or overwrite the older messages without the control of the cell or mobile phone operator. Periodically, when the cell or mobile phone operator receives a new voice mail or message, the cell phone company may require the owner to enter the option mode before allowing the owner to listen to the new voice mail or message. As the number of voice mails or messages are stored by the operator increases, this practice of periodically requiring the operator select the option mode and review voicemail or messages becomes a nuisance and increases the cell or mobile phone usage time, thereby causing the cell or mobile phone owner to increase his/her minutes of time used and potentially causing tie-up of cell phone lines.

Cell or mobile phones are also currently offering owners to record calls or conversations. These recorded calls are processed, stored and accessed similarly to the voice mail or messages. Consequently, the limitations and nuisance factors associated with voice mail or messages are also applicable to recorded calls. The present invention provides a method to efficiently download or transfer cell or mobile voice mail or messages or recorded phone calls from the cell or mobile phone company's storage medium to the owners electronic mail account (e-mail) or hard media. Within this patent application, the term ‘voice mail’ is intended to include voice mail or messages as well as recorded calls or conversations.

Cell or mobile phone operators generally select the option to save certain voice mail or messages or to record and save certain phone calls or conversations due to their importance to the operator. For example, a message from a loved one or a conversation of legal significance may be saved. There are many reasons why an operator may want to save a voice mail or message or recorded call for an extended period. However, the options for downloading the stored voice mail or message or recorded phone call is limited to either 1) recording the voice mail, message, or call from the cell or mobile phone's speaker into a microphone of a tape or digital recording device, or 2) using a commercially available software product to transfer the data from the phone to a computer via an electrical connection. In addition, it is contemplated by the Applicant that the operator may resort to various technologies to download the voice mail or message from one's phone to a computer via serial, parallel or universal serial bus (USB) wire connections. Wireless technology such as Bluetooth, WiFi or infrared technology (IRDA) are other methods that may be utilized to transfer the voice mail or message to the operator's computer. Disadvantages common to all of these technologies the operator must set up and use auxiliary equipment, the process takes time, and, typically, the operator must be in close proximity to his or her computer to facilitate the transfer.

There are commercial products which allow communication between computers and cell or mobile phones. Such products are commercially known as DataPilot and Future Dial. Susteen company, located in Irvine, Calif., markets the DataPilot product which provides Phone Book Manager, Dial Up, Ringtone Composer, Image Editor, SMS Manager and Calendar support in one software. DataPilot supports the most popular cell phones on the market which includes more handsets and features for individual cell phone models. DataPilot has Calendar support for cell phones models that have that capability. DataPilot also allows users or owners to import their Outlook and Palm Pilot data. Future Dial, a company located in Sunnyvale, Calif., markets a product termed ‘SnapSync’. FutureDial's SnapSync™ Software allows users or owners to save phonebook data and MS Outlook™ or Outlook Express™ contact information and to share this data and information between their PC and mobile phones. These software products are designed to enable owners to keep their cell or mobile phone's important contact information up-to-date, and securely backed-up, while they may be at work, at home, or traveling. However, neither Datapilot nor Future Dial allow owners to download voice mail or messages or recorded calls from their cell or mobile phones to their personal computers because the cell or mobile phone does not store the voice mail or messages or recorded calls but rather these are stored in a remote location operated by the cell or mobile phone service or company.

Other recorders (e.g. Microsoft Recorder) and encoders (e.g. Microsoft Media Encoder) are commercially or shareware available for inputting sound into a sound card of a computer and correspondingly for writing software files. For example, Wav files, can be played by commercially or shareware available audio players (e.g. Microsoft Media Player) or can further encode the sound captured written software until other commercially and shareware available formats, e.g. MP3. These software techniques have the disadvantage that the cell or mobile phone or a land phone that has access to the cell or mobile phone voice mail or message system must have an output means (e.g. output connector) and must be physically in close proximity to the computer for audio downloading.

### SUMMARY OF THE INVENTION

Disclosed herein is a method which allows the cell or mobile phone company or the cell phone operator to download voice mail, one or more recorded messages and/or recorded communications, to the registered phone owner's personal e-mail account in a format utilized to store and playback the voice mail or messages from the individual's computer as needed. The option mode on the cell or mobile phone can be programmed to allow the cell or mobile phone owner to download one or more voice mail or messages to his/her personal e-mail account or, alternately, copy or transfer voice mail or messages to a hard media and specify delivery of this data by a know means (e.g. postal service) to their street or postal address. In addition, should the number of voice mails or messages meet or exceed the number, time, and/or duration storage limits of the cell or mobile phone's database for the particular individual's account, the mobile phone company can initiate the downloading of voice mail or messages There are commercial products which allow communication between computers and cell or mobile phones. Such products are commercially known as DataPilot and Future Dial. Susteen company, located in Irvine, Calif., markets the DataPilot product which provides Phone Book Manager, Dial Up, Ringtone Composer, Image Editor, SMS Manager and Calendar support in one software. DataPilot supports the most to the phone owner's personal e-mail account or, alternately, provide copies on a hard disk or chip media for mail delivery to the phone owner. Also, if desired, the cell phone company or owner may specify an automatic or periodic downloading and delivery of voice mail to a specified e-mail account or mail address. There are several advantages to the present invention method. First, the individual has the option to download important voice mail or message directly to his e-mail account or deliver voice mail or messages in a hard media format for storage on his/her computer. This reduces the nuisance factors encountered with prior means described above. Second, the mobile company's option to download voice mail or messages that meet or exceed a storage limit(s) reduces the need for maintaining large capacity databases on large capacity hard disks or other storage medium. Further, should there be a loss, destruction, or in-operation of the hard disk or other storage medium, the individually stored voice mails or messages might become permanently lost. This situation could impart some form of liability to the cell or mobile phone company, depending on the contractual relationship with the cell or mobile phone owner. The present invention may also be used to backup voice mail, enable a second saved source for voice mail, or permanently save important voice mail.

Since cell or mobile phone voice mail or message are already stored in a digital format using vocoder (voice coding) techniques, the means to convert stored data in a particular stored digital format can be efficiently performed using one of the typical sound generating formats found on computers, e.g. IBM-PC compatibles or Apple Macintosh computers. Some common known and use formats are WAV, Windows Media Audio Series, RealAudio, Quicktime6, Wave64, OGG Vorbis, MP3, MIDI, CD Audio, Perfect Clarity Audio and Dialogic VOX ADPCM and AIFF format files. Other audio or movie formats that might be utilized include Windows Video, Windows Media Movie Series, RealVideo, MPEG 1 and 2 video and Quicktime Movie. In addition, the personal computer format can consist of an audio format that can be utilized on a Window operating systems, Apple operating systems, Unix or Linux operating systems, palm pilot operating systems and Windows CE operating systems. The Applicant discloses that the encoding of vocoder file to a popular audio file format can occur on the owner's premises or under the control of the cell or mobile phone service or company. Alternately, the vocoder data files can be transferred without any conversion and subsequently be subject to processing by an appropriate encoder program located on the cell or mobile phone owner's computer.

It is a function of the present invention method to facilitate the transfer and export of voice mail (one or more recorded phone messages and communications) 1) to a cell or mobile phone owner's e-mail account in a format which allows the customer to play and listen to voice mail and messages that are stored now on his or her computer, or 2) to hard media such as CD or DVD with subsequent delivery to or receipt by the owner.

It is a function of the present invention method to allow a cell or mobile phone user or owner to select a storage option on his or her cell or mobile phone which downloads stored voice mails or messages to the individual's e-mail account or to a hard medium.

It is also a function of the present invention method to allow a cell or mobile phone company to download voice mails or messages to a customer's specified e-mail account or to a hard medium, when the customers stored voice mails or messages meet or exceed the storage limit(s) defined by the cell or mobile phone company.

It also a function of the present invention method to decrease the storage capacity required for storing saved cell or mobile phone voice mail or messages, reduce potential liability for lost voice mails and messages for the cell or mobile phone company, and eliminate nuisance factors associated with prior means of transferring cell or mobile voice mail or messages.

### BRIEF DESCRIPTION OF THE DRAWINGS

The invention can be better understood by reference to the following description, taken in association with the accompanying drawings.

FIG. 1 is a perspective view of the cell or mobile phone service or company having a vocoder file storage facility, a high capacity storage apparatus, the owner's holding his/her cell or mobile phone, and the owner's computer showing an e-mail browser demonstrating the downloading of voice mail or messages.

FIG. 2 is a flowchart depicting the typical cell or mobile phone voice mail or messages processing states used in cell phone communications and the methods of the present method invention.

### DESCRIPTION OF THE PREFERRED EMBODIMENT

Before the present method of transferring cell phone voice mail or messages is described, it is to be understood that this application uses the terminology ‘cell or mobile phone company’ as the service provider company and its associated facilities which install, operate and maintain cell, mobile, or portable phone towers; operate and maintain Mobile Telephone Switching Offices (MTSO); provide wireless cell or mobile phone communication services; and offer customer services and have facilities which store saved cell or mobile phone voice mail or messages linked to an owner's cell phone number or account. It also should be understood that cell or mobile phone manufacturers incorporate various forms of software technology that are based upon various operating systems. The present invention method is not limited to any particular cell phone service or provider or to any cell or mobile phone manufacturer.

It must be noted that, as used in this specification and in the claims, the singular forms “a”, “and” and “the” include the plural reference unless the contexts clearly dictates otherwise. The publications and web sites discussed herein are provided solely for disclosure prior to the filing date of the present application. Nothing herein is to be construed as an admission that the present invention is not entitled to antedate such publication by virtue of prior invention.

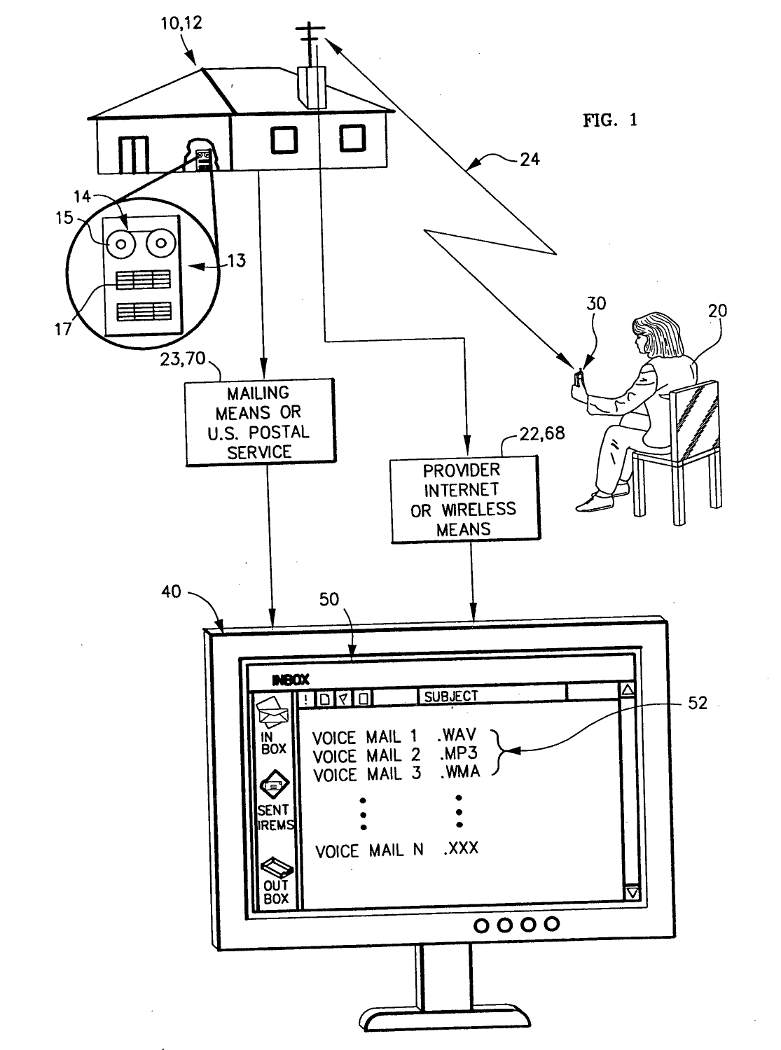

FIG. 1 is a perspective view of the cell or mobile phone company 10, voice mail or message (digital) file large capacity storage facility 12 (operated by the company or a contracted party), the owner 20 holding his/her cell or mobile phone 30, and the owner's computer 40 showing an e-mail browser 50 demonstrating the downloading of voice mail or message recordings 52. Contained within the storage facility 12 are high capacity storage apparatus 13 represented in FIG. 1 as a large capacity storage machine having a high speed tape system 15 on the top and hard medium storage apparatus (e.g. disk or chip) 17 on the bottom. A recorded and stored voice mail or message 14 is represented as stored on the high speed tape 15 but also can be stored on the hard medium 17. The recorded voice mail or message 14 is transferred from the storage facility 12 to the registered user or owner's computer 40 by utilizing internet providers or wireless means 22. Alternately, the recorded voice mail or messages can be copied on a hard media and mailed 23 to a registered address of the cell or mobile phone owner 20.

The communication means 24 and facility 10, 12 depicted on FIG. 1 are meant to represent the cell or mobile phone company structure as follows: The cell or mobile phone first communicates with remotely located base stations that are operated and maintained by the cell or mobile phone company. Each base station consists of a tower and a small building or structure that contains radio transmitter and receiving equipment. The base station towers are generally steel pole or lattice structures that typically rise hundreds of feet above the ground and are positioned at strategic locations within a coverage area. Each cell or mobile phone company runs one or more central offices called the Mobile Telephone Switching Office (MTSO) in a region that communicates with the base stations. The MTSO handles all of the phone connections to the normal land-based phone system, and control all the base stations in the region. The MTSO can be associated with a large capacity storage facility that employs large capacity hard media to record information (e.g. cell or mobile time usage, billing data, stored and recorded messages) and which may be located in close proximity with the MTSO or remotely located. The large capacity storage facility can be operated and maintained by the cell or mobile phone company or by a contracted third party storage provider.

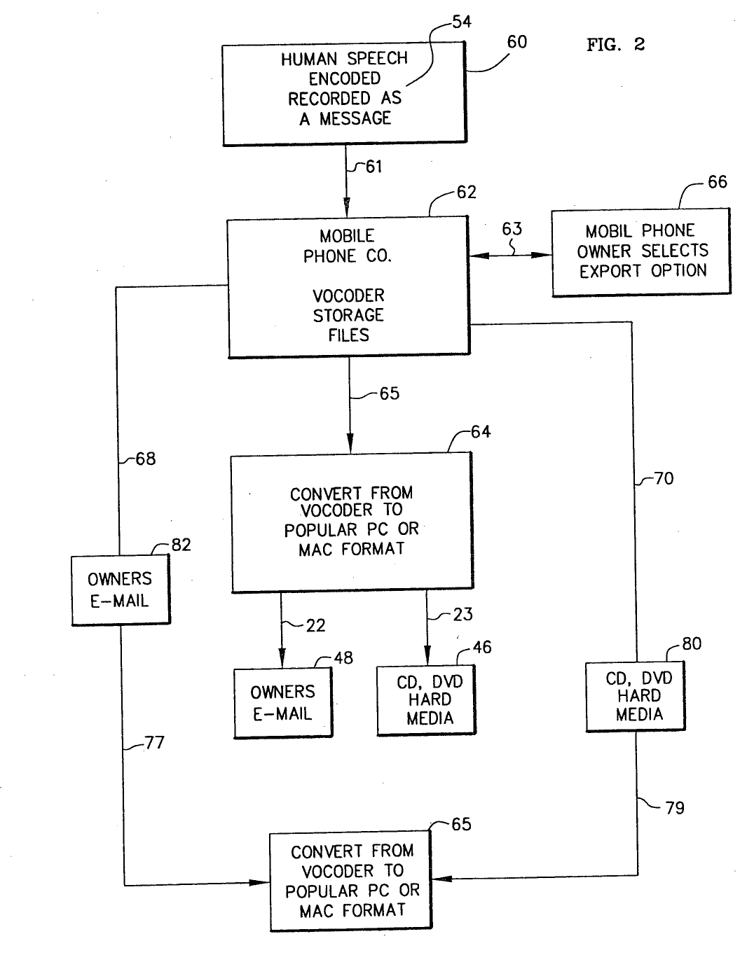

Now referring to FIG. 2, depicted is a block diagram describing the typical cell or mobile phone voice mail or message processing states used in cell or mobile phone communications and the methods of the present method invention. In the first step 60, a telephone call is initiated to a cell or mobile phone 30. If the telephone call is not answered, the caller has the option to record a voice mail or message 14. In addition, current cell or mobile phone software technology allows an user or owner 20 to record a telephone conversation or call. The recorded call is then saved as a recorded voice mail or message 14. Generally human analog speech is digitally encoded and recorded before the storage on hard or soft media is performed. As an example, in IS-95 CDMA technology, human speech is digitally encoded 54 using a technique called Code-Excited Linear Prediction (CELP). The recorded digitized voice mail or message 14 is generally stored at the cell or mobile phone company 10 or at a high capacity storage facility 12, as shown in step 62. As an example of the digitized storage format that can be electronically copy or written to hard or soft media is the vocoder format (e.g. Qualcomms PureVoice .qcp files). The Applicant recognizes that other digital storage formats are developed and utilized for encoded voice mail and messages by the various cell or mobile phone companies 10 and thus are anticipated by the Applicant. For the purposes of this application, all digitized storage formats will collectively be referred to as vocoder files or vocoder format. Overall, the present invention method allows the cell or mobile phone company 10 or the cell or mobile phone owner 20 to download one or more voice mail or message recordings 14 to a the owner's personal e-mail 48, or to transfer or send a copy of the voice mail or message recordings 14 to a hard disk or chip media 46 in an audio format that can be used to store and play the recorded voice mail or messages 14 on the owner's or other designated individual's computer 40.

As shown in step 66, the owner 20 of the cell or mobile phone 30 can access 63 and listen to the recorded and stored voice mails or messages 14. As disclosed and claimed by the present invention, once the user or owner 20 of the cell or mobile phone 30 accesses the recorded and stored voice mails or messages 14, the user or owner 20 is provided an option mode to transfer or download one or more recorded voice mail or messages 14 to their registered e-mail account 48 or alternately, have the recorded voice mail or messages 14 transferred to or copied on a hard media 46 and sent by a mailing means 23,70 (e.g. U.S. Postal Service, Federal Express, UPS) to the owners 20 registered street or postal address. The request to transfer the recorded voice mail or message 14 to the owner's registered e-mail account 48 or copied to hard media 46 and send by a mailing mean 23,70 will be subsequently processed at the discretion of the cell or mobile phone company 10. The transfer or downloading of recorded voice mail or messages 14 to an e-mail account 48 can be processed at a higher frequency than copying the recorded voice mail or message 14 to a hard media 46 and using a mailing means 23,70 to deliver the media to the owner 20.

In addition, the downloading of recorded and stored voice mail or messages 14 can be initiated by the cell or mobile phone company 10 without any direct intervention by the cell or mobile phone owner 20. In this embodiment, should the number of stored voice mail or message recordings 14 meet or exceed the number, time, and/or duration storage limits designated by the cell or mobile phone company's policy for that particular individual's account, the cell or mobile phone company 10 can download one or more of the saved or stored voice mail or message recordings 14 to the cell or mobile phone owner's personal or registered email account 48 or, alternately, can provide copies of the saved or stored voice mails recordings 14 on a hard disk or chip media 46 for delivery to the cell or mobile phone owner. The downloading completed by the cell or mobile phone company 10 can occur at a specific frequency e.g. hourly, daily, weekly, or can be completed at irregular frequencies. For example, if the cell or mobile company has a policy time storage limit that downloads all or a portion of the recorded and stored voice mail and messages 14 held in an account for a period of twenty-one days, or more specifically 504 hours, then, once this time limit is met, the downloading of the recorded and stored voice mail or message 14 can automatically occur whereby the transfer ensues over the internet or wireless means 22, 68 at the 504 hour interval. Since voice mails and messages have various times and dates when recorded and stored, the transfer or download can generally be irregular in time. For example, if on October 1^{st} one voice mail or message was recorded at 10:00 a.m., another at 1:32 p.m. and a third at 5:06 p.m., then an automatic 504 hour download could commence on October 22^{nd} at 10:00 a.m., another at 1:32 p.m. and a third at 5:06 p.m., respectively. Alternately, the cell or mobile phone company 10 can batch, for example, a full month (30 days) of recorded and stored voice mail or messages 14 and then download all of the voice mail or messages that fall within that period of time. The batch method might be favored when recorded and stored voice mail and messages 14 are copies to a hard disk or chip media 46 and sent by a mail means 23, 70 to the registered address of the owner 20. If the number storage limit is employed by the cell or mobile phone company, once a certain number limit is met or exceeded, for example, 100 recorded and stored individual voice mails or messages 14 are stored in the particular owner private mail box, then the company 10 can have a policy that automatically transfers or downloads all 100 or some portion of the 100, for example 50, by either internet or wireless means 22,68 or mailing means 23,70. If the duration limit is employed by the cell or mobile phone company 10, once a certain total accumulated duration of recorded voice mail or messages is met or exceeded, then the company can automatically transfer or download all or some portion of the saved recordings. It is also contemplated that the cell or mobile phone company 10 can simultaneously use the number, time, and/or duration storage limits.

There are several advantages to the present invention method. First, the individual or owner 20 has the option to download important voice mail or messages or phone call recordings that are stored by the cell or mobile phone company 10 directly to his e-mail account 48 or delivered these to a hard media 46 format for storage on his or her computer. This reduces the nuisance caused by either recording voice mail or messages from the cell or mobile phone's speaker into a microphone of a tape or digital recording device or by using a commercially available software product to transfer the data to their computer via an electrical connection. Second, the cell or mobile company's option to download voice mail or message recordings that meet or exceed a number, time, or duration limit(s) potentially reduces the need for maintaining large databases on large capacity hard disks or other storage medium. Further, should there be a loss, destruction, or in-operation of the hard disk or other storage medium, individual stored voice mail or message recordings 14 might become permanently lost. This situation might impart some form of liability to the cell or mobile phone company 10, depending on their contractual relationship with the cell or mobile phone owner 20.

Now referring to path 65 which leads to step 64 one embodiment of the present invention is disclosed. Since the recorded and stored cell or mobile phone voice mail recordings 14 are already stored in a digital format using, for example vocoder (voice coding) technology, the means to transfer or download the particular stored digital format can be efficiently converted to one of the typical sound generating formats found on computers like IBM-PC compatibles or Apple Macintosh computers, as represented in step 64. Some commonly known and used audio formats are WAV, Windows Media Audio Series, RealAudio, Quicktime6, Wave64, OGG Vorbis, MP3, MIDI, CD Audio, Perfect Clarity Audio and Dialogic VOX ADPCM and AIFF format files. Other audio or movie formats that might be utilized include Windows Video, Windows Media Movie Series, RealVideo, MPEG 1 and 2 video and Quicktime Movie. In addition, the personal computer format can include an audio format that can be utilized in Window operating systems, Apple operating systems, Unix or Linux operating systems, palm pilot operating systems and/or Windows CE operating systems. The applicant contends that the audio format can be any format which can be stored in a digital format on a computer system and played by a computer program that converts the digitized format into an analog format that can be played over speakers, headphone or other such technology. A listing of the potential formats can be found on the website www.sonicspot.com/guide/fileformatlist.html and is incorporated in this application by reference. The converting or encoding of vocoder files to a popular PC or Macintosh audio file formats can occur on the cell phone company's 10 premises or contracted to a third party under the control of the cell or mobile phone company 10 and sent to the cell or mobile phone owner's specified e-mail account. The recorded voice mail or message 14 that has been converted to one of the popular audio formats can now be transferred by internet or wireless means 22 directly to the owner's registered e-mail account 48 or delivered on a hard media 46 by a mailing means 23.

Alternately, the vocoder files can be transferred to the owner's e-mail account 48 by internet or wireless means along path 68 without any conversion which is subsequently processed by an appropriate conversion program located on the cell or mobile phone owner's computer. The conversion programs can be sold, leased, or otherwise provided by the mobile or cell phone service/provider or another third party to the cell or mobile phone owner 20 to install on his or her personal computer system 40. Then raw, vodocer files that have been sent or transferred from the cell or mobile phone company to the cell or mobile phone owner's e-mail account via internet or wireless means 68 and can subsequently utilize (along path 77) a software program located on the owner's computer 40 to convert the vocoder file to one of the popular audio formats as desired by the owner 20.

Additionally, the transfer or download of one or more voice mail recordings 14 can be sent to the cell or mobile phone owner 20 on a hard media 46 such as a CD (compact disk) or DVD and delivered using a mail system 70 such as the U.S. Postal Service, Federal Express, UPS or other mail or delivery provider. The conversion programs can be sold, leased, or otherwise provided by the mobile or cell phone service/provider or another third party to the cell or mobile phone owner 20 to install on his or her personal computer system 40. Then raw, vocoder files copies on a hard disk or chip media 46 can utilize a mailing means 70 to send files to the cell or mobile phone owner 20 for transferring to the computers hard disk. Then subsequently the raw vocoder files (along path 79) can utilize a software program located on the owner's computer 40 to convert the raw vocoder files to one of the popular audio formats as desired by the owner 20.

I claim:

1. A method for transferring and downloading one or more voice mail or messages to a mobile phone owner, comprising the steps:
Accessing the voice mail or message system on a mobile phone;
Selecting an option to send the voice mail or message to the mobile phones owner's specified account; and
Transferring said voice mail or message in a digital format to said mobile phone owner.

2. The method as recited in claim 1, further comprising the step of converting a digital copy of said voice mail or message from a cell or mobile phone companies' format into a personal computer audio format.

3. The method as recited in claim 1, wherein said transferring of the voice mail or message is transferred to said mobile phone owner's e-mail account.

4. The method as recited in claim 1, wherein said method of transferring is by an internet means.

5. The method as recited in claim 1, wherein said method of transferring is by an wireless means.

6. The method as recited in claim 1, wherein said method of transferring is accomplished by utilizing a mailing means to deliver a hard disk or chip media having one or more voice mail or messages copied to said hard disk or chip media to the mobile phone owner.

7. The method as recited in claim 2, wherein said cell or mobile companies' format comprises a vocoder format.

8. The method as recited in claim 2, wherein said converting of a digital copy of said voice mail or message is conducted by a cell, mobile or portable phone company.

9. The method as recited in claim 2, wherein said converting of a digital copy of said voice mail or message is conducted by a third party.

10. The method as recited in claim 2, wherein said converting of a digital copy of said voice mail or message is conducted on a computer system operated by the cell or mobile phone owner.

11. The method as recited in claim 2, wherein said personal computer format is an audio format selected from the group consisting of WAV, Windows Media Audio Series, RealAudio, Quicktime6, Wave64, OGG Vorbis, MP3, MIDI, CD Audio, Perfect Clarity Audio, Dialogic VOX ADPCM and AIFF for the computers like the IBM-PC compatible and the Apple Macintosh.

12. The method as recited in claim 2, wherein said personal computer format is an audio format that can be utilized on a Window operating systems, Apple operating systems, Unix or Linux operating systems, palm pilot operating systems and Windows CE operating systems.

13. The method as recited in claim 1, wherein said transferring and downloading one or more voice mail or messages from a mobile phone owner's account to the mobile phone owner's e-mail account is repeated a plurality of times.

14. A method for transferring and downloading one or more voice mail or messages from a mobile phone owner's account to the mobile phone owner's e-mail account, comprising the steps:
One or more voice mails or messages stored on a cell, mobile or portable service or company' computer that exceeding said company's a number limit for a specified owner's personal account;
Said cell, mobile, or portable service company electing to send one or more of the exceeding number of voice mails, and
Transferring one or more voice mails or messages in a digital format to said mobile phone owner.

15. The method as recited in claim 14, further comprising the step of converting a digital copy of said voice mail or message from the cell, mobile, or portable service or companies' format into a personal computer audio format.

16. The method as recited in claim 14, wherein said transferring of the voice mail or message is transferred to said mobile phone owner's e-mail account.

17. The method as recited in claim 14, wherein said method or transferring is by an internet means.

18. The method as recited in claim 14, wherein said method or transferring is by an wireless means.

19. The method as recited in claim 14, wherein said method of transferring is accomplished by utilizing a mailing means to deliver a hard disk or chip media having one or more voice mail or messages copied to said hard disk or chip media to the mobile phone owner.

20. The method as recited in claim 15, wherein said cell, mobile or portable service or companies' format comprises a vocoder format.

21. The method as recited in claim 15, wherein said converting of a digital copy of said voice mail or message is conducted on by a cell, mobile or portable phone company.

22. The method as recited in claim 15, wherein said converting of a digital copy of said voice mail or message is conducted on a computer system operated by the cell or mobile phone owner.

23. The method as recited in claim 15, wherein said converting of a digital copy of said voice mail or message is conducted by a third party.

24. The method as recited in claim 15, wherein said personal computer format is an audio format selected from the group consisting of WAV, Windows Media Audio Series, RealAudio, Quicktime6, Wave64, OGG Vorbis, MP3, MIDI, CD Audio, Perfect Clarity Audio, Dialogic VOX ADPCM and AIFF for the computers like the IBM-PC compatible and the Apple Macintosh.

25. The method as recited in claim 15, wherein said personal computer format is an audio format that can be utilized on a Window operating systems, Apple operating systems, Unix or Linux operating systems, palm pilot operating systems and Windows CE operating systems.

26. The method as recited in claim 14, wherein said transferring and downloading one or more voice mail or messages from a mobile phone owner's account to the mobile phone owner's e-mail account is repeated a plurality of times.

27. A method for transferring and downloading one or more voice mail or messages from a mobile phone owner's account to the mobile phone owner's e-mail account, comprising the steps:
One or more voice mails or messages stored on a cell, mobile or portable service or company' computer that exceeding said company's a time limit;
Said cell, mobile, or portable service company electing to send one or more of the exceeding number of voice mails, and
Transferring one or more voice mails or messages in a digital format to said mobile phone owner.

28. The method as recited in claim 27, further comprising the step of converting a digital copy of said voice mail or message from the cell, mobile, or portable service or companies' format into a personal computer audio format.

29. The method as recited in claim 27, wherein said transferring of the voice mail or message is transferred to said mobile phone owner's e-mail account.

30. The method as recited in claim 27, wherein said method or transferring is by an internet means.

31. The method as recited in claim 27, wherein said method or transferring is by an wireless means.

32. The method as recited in claim 27, wherein said method of transferring is accomplished by utilizing a mailing means to deliver a hard disk or chip media having one or more voice mail or messages copied to said hard disk or chip media to the mobile phone owner.

33. The method as recited in claim 28, wherein said cell, mobile or portable service or companies' format comprises a vocoder format.

34. The method as recited in claim 28, wherein said converting of a digital copy of said voice mail or message is conducted on by a cell, mobile or portable phone company.

35. The method as recited in claim 28, wherein said converting of a digital copy of said voice mail or message is conducted on a computer system operated by the cell or mobile phone owner.

36. The method as recited in claim 28, wherein said converting of a digital copy of said voice mail or message is conducted by a third party.

37. The method as recited in claim 28, wherein said personal computer format is an audio format selected from the group consisting of WAV, Windows Media Audio Series, RealAudio, Quicktime6, Wave64, OGG Vorbis, MP3, MIDI, CD Audio, Perfect Clarity Audio, Dialogic VOX ADPCM and AIFF for the computers like the IBM-PC compatible and the Apple Macintosh.

38. The method as recited in claim 28, wherein said personal computer format is an audio format that can be utilized on a Window operating systems, Apple operating systems, Unix or Linux operating systems, palm pilot operating systems and Windows CE operating systems.

39. The method as recited in claim 27, wherein said transferring and downloading one or more voice mail or messages from a mobile phone owner's account to the mobile phone owner's e-mail account is repeated a plurality of times.

40. A method for transferring and downloading one or more telephone conversations recorded into a voice mail or messages to a mobile phone owner, comprising the steps:
Selecting a conversation recording option on a cell or mobile phone;
Saving the recorded conversation into a voice mail or message system;
Selecting an option to send the voice mail or message to the cell or mobile phones owner's specified account; and
Transferring said voice mail or message in a digital format to said cell or mobile phone owner.

41. The method as recited in claim 40, further comprising the step of converting a digital copy of said voice mail or message from the cell, mobile, or portable service or companies' format into a personal computer audio format.

42. The method as recited in claim 40, wherein said transferring of the voice mail or message is transferred to said mobile phone owner's e-mail account.

43. The method as recited in claim 40, wherein said method or transferring is by an internet means.

44. The method as recited in claim 40, wherein said method or transferring is by an wireless means.

45. The method as recited in claim 40, wherein said method of transferring is accomplished by utilizing a mailing means to deliver a hard disk or chip media having one or more voice mail or messages copied to said hard disk or chip media to the mobile phone owner.

46. The method as recited in claim 41, wherein said cell, mobile or portable service or companies' format comprises a vocoder format.

47. The method as recited in claim 41, wherein said converting of a digital copy of said voice mail or message is conducted on by a cell, mobile or portable phone company.

48. The method as recited in claim 41, wherein said converting of a digital copy of said voice mail or message is conducted on a computer system operated by the cell or mobile phone owner.

49. The method as recited in claim 41, wherein said converting of a digital copy of said voice mail or message is conducted by a third party.

50. The method as recited in claim 41, wherein said personal computer format is an audio format selected from the group consisting of WAV, Windows Media Audio Series, RealAudio, Quicktime6, Wave64, OGG Vorbis, MP3, MIDI, CD Audio, Perfect Clarity Audio, Dialogic VOX ADPCM and AIFF for the computers like the IBM-PC compatible and the Apple Macintosh.

51. The method as recited in claim 41, wherein said personal computer format is an audio format that can be utilized on a Window operating systems, Apple operating systems, Unix or Linux operating systems, palm pilot operating systems and Windows CE operating systems.

52. The method as recited in claim 40, wherein said transferring and downloading one or more voice mail or messages from a mobile phone owner's account to the mobile phone owner's e-mail account is repeated a plurality of times.

53. A method for transferring and downloading one or more voice mail or messages from a mobile phone owner's account to the mobile phone owner's e-mail account, comprising the steps:
One or more voice mails or messages stored on a cell, mobile or portable service or company' computer that exceeding said company's a duration limit for a specified owner's personal account;
Said cell, mobile, or portable service company electing to send one or more of the exceeding number of voice mails, and
Transferring one or more voice mails or messages in a digital format to said mobile phone owner.

54. The method as recited in claim 53, further comprising the step of converting a digital copy of said voice mail or message from the cell, mobile, or portable service or companies' format into a personal computer audio format.

55. The method as recited in claim 53, wherein said transferring of the voice mail or message is transferred to said mobile phone owner's e-mail account.

56. The method as recited in claim 53, wherein said method or transferring is by an internet means.

57. The method as recited in claim 53, wherein said method or transferring is by an wireless means.

58. The method as recited in claim 53, wherein said method of transferring is accomplished by utilizing a mailing means to deliver a hard disk or chip media having one or more voice mail or messages copied to said hard disk or chip media to the mobile phone owner.

59. The method as recited in claim 54, wherein said cell, mobile or portable service or companies' format comprises a vocoder format.

60. The method as recited in claim 54, wherein said converting of a digital copy of said voice mail or message is conducted on by a cell, mobile or portable phone company.

61. The method as recited in claim 54, wherein said converting of a digital copy of said voice mail or message is conducted on a computer system operated by the cell or mobile phone owner.

62. The method as recited in claim 54, wherein said converting of a digital copy of said voice mail or message is conducted by a third party.

63. The method as recited in claim 54, wherein said personal computer format is an audio format selected from the group consisting of WAV, Windows Media Audio Series, RealAudio, Quicktime6, Wave64, OGG Vorbis, MP3, MIDI, CD Audio, Perfect Clarity Audio, Dialogic VOX ADPCM and AIFF for the computers like the IBM-PC compatible and the Apple Macintosh.

64. The method as recited in claim 54, wherein said personal computer format is an audio format that can be utilized on a Window operating systems, Apple operating systems, Unix or Linux operating systems, palm pilot operating systems and Windows CE operating systems.

65. The method as recited in claim 53, wherein said transferring and downloading one or more voice mail or messages from a mobile phone owner's account to the mobile phone owner's e-mail account is repeated a plurality of times.
